(19) United States
(12) Patent Application Publication
(10) Pub. No.: US 2026/0009145 A1
(43) Pub. Date: Jan. 8, 2026

(54) ELECTROLYSIS SYSTEM

(71) Applicant: Siemens Energy Global GmbH & Co. KG, München (DE)

(72) Inventors: Marvin Bendig, Zirndorf (DE); Ulf-Andre Geck, Herzogenaurach (DE); Sven Schumann, Wilhermsdorf (DE)

(21) Appl. No.: 19/102,489

(22) PCT Filed: Jul. 21, 2023
(86) PCT No.: PCT/EP2023/070342

§ 371 Date: Feb. 10, 2025

(30) Foreign Application Priority Data
Aug. 9, 2022 (DE) 10 2022 208 258.3

(51) Int. Cl. C25B 9/70; C25B 9/65; H02J 3/38; H02M 1/10; H02M 3/156; H02M 7/797

(52) U.S. Cl. CPC C25B 9/70; C25B 9/65; H02J 3/381; H02M 1/10; H02M 3/156; H02M 7/797; H02J 2300/24; H02J 2300/28

(57) ABSTRACT

An electrolysis system has at least two electrolysis installations, a power supply source with a direct voltage output, and a central supply line connected to the direct voltage output. A direct current, at a first direct voltage, can be fed into the central supply line. The electrolysis installations are connected electrically in parallel to the central supply line. For a direct voltage supply from the public power grid a central voltage source converter converts an input-side alternating voltage into the output-side first direct voltage at a direct voltage output. Each electrolysis installation is connected via a DC/DC converter that converts the first direct voltage into a second direct voltage, parallel to the direct voltage output so that the second direct voltage drops across the electrolysis installation. Each of the DC/DC converters can be controlled and/or regulated for adapting a level of its second direct voltage.

The invention relates to an electrolysis system comprising at least two electrolysis installations and a power supply source.

Electrolysis operations, i.e. processes in which a chemical reaction is initiated by means of an electric current, are applied in numerous technical fields and are employed, for example, for the recovery of various substances. For example, by means of electrolysis, hydrogen and oxygen can be obtained from water. For the operation of electrolysis devices, also described as electrolysis stacks or electrolysers, or as electrolysis installations, particularly on an industrial scale, it is desirable that the most energy-efficient and reliable operation thereof should be possible.

Nowadays, hydrogen is produced from water, for example by means of proton exchange membrane (PEM) electrolysis, anion exchange membrane electrolysis or alkaline electrolysis. By means of electrical energy, electrolysis installations generate hydrogen and oxygen from an infeed of water. This process is executed in an “electrolysis stack”, which is comprised of multiple electrolysis cells. In turn, the electrolysis stack can be formed of multiple electrolysis modules which, in turn, are comprised of multiple electrolysis cells. In the electrolysis stack, to which a direct voltage (DC voltage) is applied, water is introduced as an educt wherein, further to the throughflow thereof in the electrolysis cells, two fluid streams are discharged, comprised of water and gas bubbles (O₂ or H₂).

It is already known that, to this end, multiple electrolysers or electrolysis installations can be electrically connected, for example in parallel, wherein each of the electrolysers is supplied with power from a dedicated and galvanically isolated circuit comprised of a transformer having tap changers for the coarse-step control of electrolysers, and a rectifier having a thyristor circuit for the fine control of the electrolysis installation, which represents a highly complex implementation. Alternatively, for the reduction of circuit complexity, it is also known for electrolysers to be parallel-connected and operated via a rectifier wherein, however, a power distribution can occur in response to the resistance ratios of electrolysers, thereby resulting in a substantial derating and the potential risk of the operation of one or more electrolysers outside their secure operating ranges.

For the operation of water electrolysis installations, a high direct current is required. As the electric power supply grid is typically operated as an AC power grid, the employment of power electronic rectifiers is necessary for the connection of the electrolysis system to the grid. In future industrial-scale installations employing existing design concepts, as a result of this circumstance, it will be necessary for numerous parallel-operated rectifier systems to be employed.

Thus, in EP 3 752 665 A1, a network connection of an electrolysis installation having multiple parallel-connected electrolysers is disclosed. The rectifier comprises a thyristor stack having a multiplicity of thyristors. By an actuation of the rectifier, the level of the DC output voltage can be adjusted. The facility for the control of the rectifier is executed by the selection of the ignition times of thyristors in the thyristor stack. For the stabilization of the DC voltage which is generated by the rectifier, according to EP 3 753 665 A1, a capacitor is further provided, which is connected in parallel to the output of the rectifier. An adjustable filtering device is further provided, having an inductance and a capacitance, by means of which it is possible to damp a harmonic which is produced by the rectifier, and which is generated in-service by the switching of the thyristor stack of the rectifier.

In future industrial-scale installations having a plurality of electrolysis installations in an electrolysis system, for the grid system connection thereof, it would therefore be necessary to provide a corresponding number of power electronic rectifiers, which are employed in a complex rectifier system and are parallel-connected, in order to permit the delivery of the high DC power demand of electrolysis installations. On the grounds of the grid system perturbation associated with the harmonics—or “harmonic response”—of thyristors, this is only achievable by means of a correspondingly high complexity of filtering arrangements and, in particular, is associated with substantial additional costs for the installation and operation of the filtering system. Accordingly, in industrial-scale installations, the technical limitations and complexity associated with widespread thyristor-based rectification are highly disadvantageous. However, in previously known design concepts, this has been accepted, on the grounds that thyristor systems represent a proven technology.

The fundamental object of the invention is therefore the disclosure of an electrolysis system having a DC power supply for multiple parallel-connected electrolysis installations, which is designed for industrial-scale installations and which provides cost advantages over known approaches, and simultaneously having a superior operating performance with respect to energy-efficient operation.

According to the invention, this object is fulfilled by an electrolysis system comprising at least two electrolysis installations, a power supply source having a DC voltage output and a central supply line, wherein the central supply line is connected to the DC voltage output of the power supply source, such that a direct current having a first DC voltage can be injected into the central supply line, and wherein the electrolysis installations are electrically connected in parallel to the central supply line, wherein, for the DC power supply from the public power grid, a voltage source converter (VSC) is connected at a network connection point, in particular a modular multilevel converter (MMC), which converts an input-side AC voltage into the output-side first DC voltage at the DC voltage output, wherein each electrolysis installation is respectively connected via a DC/DC converter which converts the first DC voltage into a second DC voltage and which is parallel-connected to the DC voltage output of the voltage source converter (VSC), in particular of the modular multilevel converter (MMC), such that the second DC voltage drops across the electrolysis installation, wherein each of the DC/DC converters can be controlled and/or regulated for adjusting a level of the second DC voltage thereof, and wherein actuatable bridging switches are provided such that, where a bridging switch is closed, a respective DC/DC converter can be bridged, such that the connected electrolysis installation can be directly energized by the first DC voltage.

By means of the invention, in an electrolysis system, by the advantageous cooperation of a voltage source converter (VSC)—in particular an IGBT-based converter, for example a modular multilevel converter (MMC)—at the network connection point with the respective DC/DC converters of the electrolysis installations, an individual power control for electrolysis installations is achieved for the first time.

By means of the central voltage source converter (VSC) which, for example, is embodied as a modular multilevel converter (MMC), in the event of a network connection at the network connection point, a conversion of alternating current into direct current is executed only once. To this end, at the connection, an IGBT-based rectifier is employed which, for example, is provided in the form of a modular multilevel converter. A central connection of the voltage source converter (VSC) which, in particular, is embodied as a modular multilevel converter (MMC), to an AC power grid thus enables a DC electric power for electrolysis operations to be delivered at the DC voltage output on the central supply line, at the first DC voltage. In its function, the central supply line thus functions as a DC bus conductor, which supplies electric power at the first DC voltage.

The invention thus proceeds from the finding to the effect that, at present, on the grounds of the high DC currents required for electrolysis operations, rectifiers based upon thyristor technology are primarily employed. The thyristor-based rectification and AC connection technology preferred to date is proven, reliable, and is associated with comparatively low in-service losses. However, the employment of thyristors results in substantial grid system perturbations associated with harmonics—or “harmonic response”—and is moreover associated with a high reactive power demand. Particularly in the case of future large-scale electrolysis systems having multiple electrolysis installations or electrolysers, a substantial additional demand for filtering and compensation is generated accordingly, such that both costs and spatial requirements are correspondingly increased. As both reactive power demand and harmonic responses are dependent upon the working point, it is necessary for filter systems to be rated for all the working points of a connected large-scale electrolysis installation, in order to achieve the requisite operational flexibility and network stability for a high-capacity installation on an industrial scale.

It is moreover anticipated that, in future, as a result of the increasing absence of rotating masses, e.g. in response to the shutdown of nuclear and coal-fired power plants, grid systems will be affected by a significant decline in grid system short-circuit power, and thus in network stability. It is thus increasingly important that large-scale installations—in addition to their actual function—are capable of delivering network services for the public power grid. By the employment of existing thyristor technology, this is only possible to a limited extent (active power control). Moreover, in the case of very weak networks, further additional measures are required, if thyristor technology is to be employed at all.

In the event of a combination of renewable energy generating installations (RE installations) such as, for example, a photovoltaic installation, which generates a DC voltage in an intermittent manner, with electrolysis installations, the employment of thyristor technology additionally requires a multiple conversion of the voltage form (DC-AC-DC), thereby resulting in increased costs and losses.

In the event that various thyristor rectifiers, for example in large-scale installations, are operated in parallel, these thyristor rectifiers can be supplied with phase-displaced AC voltages, in order to reduce filtering requirements. In a design concept of this type, however, it is necessary for all rectifiers to be maintained at comparatively uniform working points, or to draw a similar power. If it is necessary to envisage operation at different working points, for example in response to variations in ageing of the individual electrolysis modules, filtering requirements will again be increased. As a result, operational flexibility is substantially restricted, or is only susceptible to improvement by means of high systemic complexity and at high costs.

By means of the invention, for the first time, a voltage source converter (VSC), in particular a modular multilevel converter (MMC), is employed for transmitting power between an AC grid and a DC grid in an electrolysis system, thus providing numerous advantages over a thyristor-based power supply topology. It is particularly advantageous that, by means hereof, in an electrolysis system, a bidirectional power transfer is enabled between the public power grid and the central supply line, thereby enabling the provision of network services such as, for example, voltage support, or the assumption of network configuration functions.

The employment of insulated-gate bipolar transistors (IGBTs for short) in the modular multilevel converter for the supply of direct current to the electrolysis system has proved to be particularly advantageous for the operating performance of the electrolysis system. The IGBT is a semiconductor component which is employed in power electronics, as it combines the advantages of a bipolar transistor, such as a good conducting-state characteristic, a high off-state voltage and robustness, with the advantages of a field-effect transistor associated with a virtually powerless actuation. The employment of IGBTs is widespread, for example, in a “three-phase B6 bridge circuit” with an IGBT-based rectifier, as a result of which a highly accurate control of the electrolysis current is achieved, with effective rectification. The distinctive advantages of IGBTs are the high voltage and current limits thereof: voltages of up to 6500 V and currents of up to 3600 A, at a power rating of up to several megawatts, predefine the suitability of IGBTs for employment in electrolysis installations. Consequently, the employment of IGBTs for the voltage source converter (VSC) which, in particular, is embodied as an IGBT-based modular multilevel converter (MMC), is particularly advantageous in the context of the electrolysis system according to the invention which is proposed herein.

On the electrolysis side, the respective DC/DC converters reduce the first DC voltage for an electrolysis installation to a respective second DC voltage which assumes an individually desired value, with no significant conversion losses. Accordingly, in the electrolysis system, electrolysis installations are both controllable with respect to the electrolysis power, and can also be switched on and off. A part-load capability or part-load actuation is achieved by the regulation of the electrolysis current. Moreover, if required, by a tuning of the load controller—additionally or alternatively to a network connection to the public power grid—a capability for separate network operation can be guaranteed, which is associated with substantial cost advantages, for example in the case of remote on-shore installations or off-shore installations. In order to deliver higher electrolysis currents, if required, multiple DC/DC converters can be connected in parallel and employed in a respective connection line.

For a further improvement of energy efficiency in the electrolysis system, it is additionally provided that the system comprises multiple actuatable bridging switches such that, in a connection line, if required, a respective DC/DC converter, e.g. an IGBT-based step-down converter, can be bridged by means of a respectively assigned actuatable bridging switch. The bridging of a DC/DC converter thus entails a complete drop of the first DC voltage across the electrolysis installation which is connected to the bridged DC/DC converter. In bridged DC/DC converters, the second DC voltage thus corresponds to the first DC voltage. An operation of the DC/DC converter such that the second DC voltage, i.e. the output voltage of the DC/DC converter, insofar as possible, assumes an equal magnitude to the first DC voltage, i.e. the input voltage of the DC/DC converter, can be replaced by the bridging of the DC/DC converter. As a result, electrical losses associated with routine operation, in which the DC/DC converter is energized, can be prevented. Thus, advantageously, in the interests of a particularly energy-efficient operation, for example, only those electrolysis installations having the lowest resistances are supplied via the DC/DC converter, whereas other electrolysis installations are supplied directly with the first DC voltage. Actuation of the respective bridging switches can be executed, for example, by a central computing device of the electrolysis system, wherein the computing device, in particular, is also configured for controlling and/or regulating the DC/DC controller. As a result, in the electrolysis system, a bridging device having a number of actuatable bridging switches is provided, and a particularly advantageous and energy-efficient capacity utilization control function for electrolysis installations which are connected to the central DC supply line is enabled.

In a particularly preferred configuration of the electrolysis system, the DC/DC converter is embodied in the form of an IGBT-based step-down converter for the individual load control of the electrolysis installation.

Preferably, in particular, the voltage source converter (VSC) embodied as a modular multilevel converter (MMC), is designed for bidirectional operation, and is connected to a central network connection point, such that a voltage support function can be executed by the supply of reactive power for the public power grid.

Advantageously, the provision of further network services is also possible, including, for example, the assumption of network configuration functions.

It is further preferred that the voltage source converter (VSC) is embodied as an IGBT-based modular multilevel converter such that, if required, electric power can be injected from the central supply line into the public power grid at the network connection point. This is a specific and advantageous form of a bidirectional operation of the electrolysis system. This is possible in the event that surplus power is available on the central supply line, the take-up of which cannot be executed by the electrolysis installation, for example on the grounds of an additional injection of DC electric power from a renewable energy generating installation (RE installation) into the central supply line, or in the event of a part-load operation or maintenance of individual electrolysis installations or modules of the electrolyser. In normal duty, an MMC thus optionally transmits power from the DC side to the AC side, or vice versa, which is conducive to a particularly flexible operational management of the electrolysis system.

In a preferred configuration, the electrolysis installations, with respect to the central supply line, are connected in a mutually parallel arrangement, such that an electrolysis installation is connected by means of a respective connection line to the central supply line.

As a result, the central DC supply line exploits the advantages of the DC bus principle, which principle enables, and also provides for a respectively independent connection line for an electrolysis installation. In the electrolysis system, if required, the central DC power supply grid is extendable in a flexible manner, and can be expanded to incorporate further electrolysis installations, optionally by the adjustment of the infeed capacity of power supply sources which inject power into the DC grid, in consideration of the requisite power take-up of electrolysis installations or electrolysers.

In the event of a power take-up via the network connection point on the public power grid, this operation can be executed and adjusted in a flexible manner, by means of the central modular multilevel converter.

Thus, a respective IGBT-based step-down converter is preferably connected in a connection line, the input voltage of which corresponds to the first DC voltage, and the second DC voltage of which is adaptable to a respective operating voltage of the electrolysis installation.

Accordingly, the requisite operating voltage at the output of the IGBT-based step-down converter in the respective connection line is individually adaptable and adjustable to the level of the individual electrolysis installation. In this connection line, an accurate regulation and control of the second DC voltage, and thus of the operation of the electrolysis installation, is achieved.

The employment, optionally, of multiple high-voltage DC/DC converters, which are embodied with a modular design and are parallel-connected in a connection line, is particularly advantageous. As a result, a combined industrial application, in an electrolysis system having a number of electrolysis installations, is enabled.

The step-down converter (or buck converter), by way of an input voltage, converts the first DC voltage on the central DC supply line into a second DC voltage, which is a lower output voltage. This converter is also described as a buck regulator.

A connection line advantageously forms a DC line or DC spur from the central supply line for one or more electrolysis installations or electrolysers in the relevant connection line which are operable by a direct current. Thus, on one or more such central DC spurs, advantageously, by means of regulatable IGBT-based DC/DC converters, in particular “buck regulators” or step-down converters, an arbitrary number of arbitrarily dimensioned electrolysis installations can be connected, such that the electrolysis system is expanded accordingly.

In a particularly preferred configuration, in a connection line, the step-down converter is embodied with a modular design, wherein a step-down converter comprises at least two parallel-connected DC/DC step-down converters, the input voltage of which corresponds to the first DC voltage.

Preferably, the at least two parallel-connected DC/DC step-down converters of the modular step-down converter, on the output side, are mutually electrically connected, and are respectively rated for regulating the second DC voltage.

As a result, in a connection line, in each case, an accurate regulation of the electrolysis power to the respective operating voltage of the supplied electrolysis installation is enabled, depending upon the operating situation. The IGBT-based and modular supply topology enables a load control and a tolerance of operational faults or outages such that, in the event of a fault, a further operation of individual modules of the electrolysis installation is possible. Operational security and cost-effectiveness are enhanced accordingly. A further advantage is provided, moreover, in that the parallel-connected DC/DC converters can be operated in an “interleaved” operating mode, as a result of which, firstly, the quality of direct current is enhanced, which improves the efficiency of the electrolysis cells, and, additionally, the design of passive components, such as inductances, is simplified.

The employment of IGBT-based DC/DC converters in a connection line thus enables an individual load control of individual electrolysis trains in the connection lines, with no significant impact upon grid system perturbations. By a modular design of DC/DC converters, a cost reduction can also be achieved. Moreover, the modular design approach enables an optionally reduced further operation of the electrolysis installation, in the event of individual semiconductor faults. In presently preferred solutions involving thyristors, a semiconductor fault results in a total loss of the rectifier train or of the associated module series of electrolysis installations, which can only be rectified by means of a complex repair, such that it is necessary for downtimes to be incorporated in design calculations.

In the interests of the improvement of energy efficiency in the electrolysis system, it can be provided that this system comprises multiple bridging switches wherein, in a connection line, the IGBT-based step-down converter, if necessary, can be respectively bridged by means of one switch.

In the event of a bridging of a step-down converter, a complete drop of the first DC voltage occurs across the electrolysis installation which is connected to the bridged step-down converter. In the case of bridged step-down converters, the second DC voltage thus corresponds to the first DC voltage. An operation of the step-down converter such that the second DC voltage, i.e. the output voltage of the step-down converter, insofar as possible, assumes an equal magnitude to the first DC voltage, i.e. the input voltage of the step-down converter, can be replaced by the bridging of the step-down converter, such that losses which would be generated by such an operation of the step-down converter can be prevented. Thus, advantageously, in the interests of particularly energy-efficient operation, for example, it is possible for only those electrolysis installations having the lowest resistances to be supplied via the step-down converter, whereas other electrolysis installations are supplied directly with the first DC voltage. The actuation of switches can be executed, for example, by a computing device of the circuit arrangement wherein, in particular, the computing device is also configured for controlling and/or regulating the step-down converter.

The proposed electricity supply topology in an electrolysis system, in comparison with known approaches, moreover provides an improvement of flexibility, in a variety of respects. The employment of an IGBT-based modular multilevel converter (MMC) at a central network connection point enables the provision of further network services for the public power grid. Renewable energy installations such as, e.g. a wind power installation or a photovoltaic installation can moreover inject electrical energy generated directly into the central supply line, which is configured as a DC bus, and electrolysis installations in the respective connection lines can be regulated in a mutually independent manner.

In consequence, a step-down converter of a modular design is preferably connected to an electrolysis installation having a plurality of electrolysis modules which are electrically arranged consecutively in-circuit.

As a result, in a connection line, a regulated DC power supply of the electrolysis installation having the electrolysis modules is achieved. In consequence, it is possible for the total electrolysis power in a connection line to be regulated in a demand-specific manner, by means of the regulated DC power. In particular, a part-load operation can be introduced in an electrolysis installation, in the event that the supply of electric power on the central DC supply line is reduced, or in the event that a short-term reduction of hydrogen production is required. It is also possible, and particularly advantageous, that the electrolysis modules of an electrolysis installation can be individually bridged by means of a bridging circuit having a switchable bridging line and having an actuatable electric switch, and that an electrolysis module of an electrolysis installation can be withdrawn from service, if required, for example for maintenance purposes or for a part-load operation of the electrolysis installation.

In a preferred configuration, the step-down converter is therefore configured as a controllable buck regulator, such that the supply of electrolysis current to the electrolysis installation can be adapted to an optionally fluctuating infeed power of the power supply source into the central supply line.

By means of the controllability of the buck regulator, a flexible and, with respect to electrolysis power, adaptable supply of DC electrolysis current to the electrolysis installation in a connection line is enabled. Whether a continuous or intermittent operation of the step-down converter is in force is dependent upon inductance, the switching frequency, the input voltage, the output voltage and the output current flux. In the design of a circuit, in particular of a controller, as these parameters can, in some cases, undergo very rapid variation, it is generally necessary for the transition between these two types of operation to be considered (e.g. prevented). These two types of operation are distinguished with respect to their control characteristic, i.e. the dependence of the output voltage upon the duty factor, and with respect to the emission of interference.

The step-down converter is preferably configured as a controllable buck regulator, having output voltage control by means of a pulse-width modulation method, in continuous operation. In this manner, a continuous operation of the buck regulator is achieved, and a controllability of the electrolysis current which is fed to an electrolysis installation in the respective connection line is enabled.

In a further preferred configuration of the electrolysis system, the power supply source, by way of a power generator, comprises a wind power installation, to which a rectifier is connected having a DC voltage output, wherein the DC voltage output is rated for the first DC voltage.

In this manner, in the electrolysis system, by means of the central DC supply line, a connection or DC power connection and supply of electrolysis installations by a wind power installation or wind farm is enabled, wherein a separate network operation is advantageously possible. If the electrolysis system is operated in a separate network, no connection, or activation of a connection to the public power grid is executed, in consequence whereof the network connection at the network connection point can be interrupted, if required, i.e. the central modular multilevel converter can be withdrawn from service, or even omitted. However, a bidirectional operation is possible at any time, such that an injection into the public power grid is also possible. It is also possible that the renewable energy installation already supplies a direct current at an appropriate voltage level, in which case no further rectifier is required for the injection of power generated from renewable energy.

In a further preferred configuration, the power supply source, by way of a power generator, comprises a photovoltaic installation, the DC voltage output of which is rated for the first DC voltage, wherein the DC voltage output is connected to the central supply line.

The DC voltage level on the DC voltage output can thus be flexibly adapted to the predetermined first DC voltage on the central DC supply line. If necessary, for the adjustment of the predetermined DC voltage level on the DC voltage output, step-up converters, or “boost converters” are connected down-circuit of the PV generator. This is required, in the event that the DC output of the photovoltaic installations itself does not deliver a sufficiently high DC voltage level for injection into the central supply line.

By means of this configuration, in the electrolysis system, via the central DC grid, an advantageous link or connection and supply of an electrolysis installation with power which is generated from a photovoltaic installation is enabled on the central supply line. If necessary, separate network operation on the basis of photovoltaic energy is also possible. In an analogous manner, and in accordance with the advantages associated with the above-mentioned connection of the electrolysis installation to a wind power installation, operation in a separate network is executed independently of the public power grid, which enables a particularly high degree of flexibility in design, together with options for autonomous application, independently of the public power grid, if necessary, or additionally to a network connection, which is also possible for a bidirectional operation of the electrolysis system, by means of the modular multi-level converter. For the injection of PV power into the central supply line, if necessary, a boost converter (DC/DC converter) is provided on the PV side, for a requisite voltage step-up of the PV generator, in order to enable the execution of an accurate injection of direct current at a predetermined first DC voltage into the central supply line.

Preferably, in the electrolysis system, the central supply line is rated for operation at a first DC voltage in the medium-voltage range of 20 kV, in particular between 1.5 kV and 30 kV. An adaptation to the operating voltage of electrolysis installations in the electrolysis system is thus executed in the design rating thereof. Ratings for higher operating voltages of 10 kV to 30 kV can be provided in a flexible manner, if required.

However, the DC voltage level at the DC voltage output of the voltage source converter (VSC), in particular of the modular multilevel converter, is flexibly adaptable to the respective requirement of the electrolysis system and the transmission link wherein, preferably, a high output voltage is selected as the predetermined first DC voltage, preferably at least greater than 1.5 kV. In this case, for the design rating and configuration of the DC voltage level on the central supply line, recourse is also possible, for example, to the rated voltages of system levels which are customarily employed for energy transmission, or these values can be employed as reference points for the DC voltage level of the first DC voltage. Electrical energy is transmitted on high-voltage lines, at various medium-voltage and high-voltage system levels, at the following customary rated voltages: a medium voltage of 3 kV, 6 kV, 10 kV, 15 kV, 20 kV or 30 kV, or a high voltage of 60 kV or 110 kV. The central supply line thus functions, in a highly advantageous manner, as a central DC bus conductor, by means of which a high-voltage-based DC power supply of electrolysis installations in the electrolysis system is directly enabled.

Further advantages, features and details of the invention proceed from the following description of preferred exemplary embodiments, and from the drawing. Features and combinations of features specified in the preceding description, and features or combinations of features which are specified in the following description of the figures and/or which are represented in the figures alone, are not only employable in the respectively indicated combination, but can also be employed in other combinations, or in isolation, without departing from the scope of the invention.

Exemplary embodiments of the invention are described in greater detail with reference to a drawing. In the drawing, in a schematic and highly simplified representation:

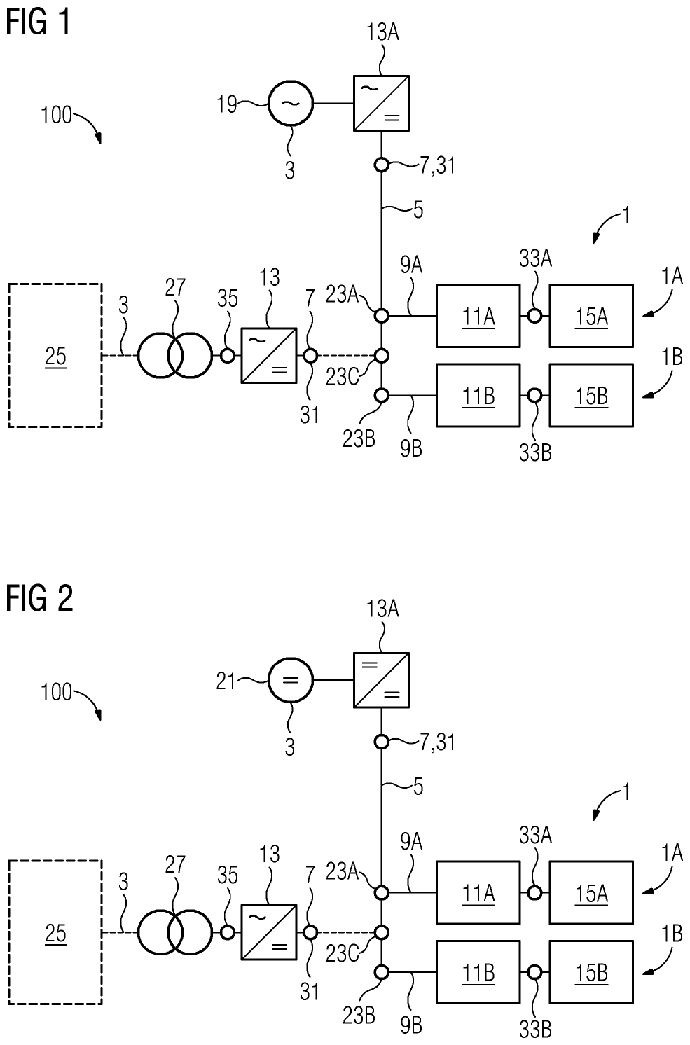

FIG. 1 shows an electrolysis system having an electrolysis installation and a wind power installation;

FIG. 2 shows an electrolysis system having an electrolysis installation and a photovoltaic installation;

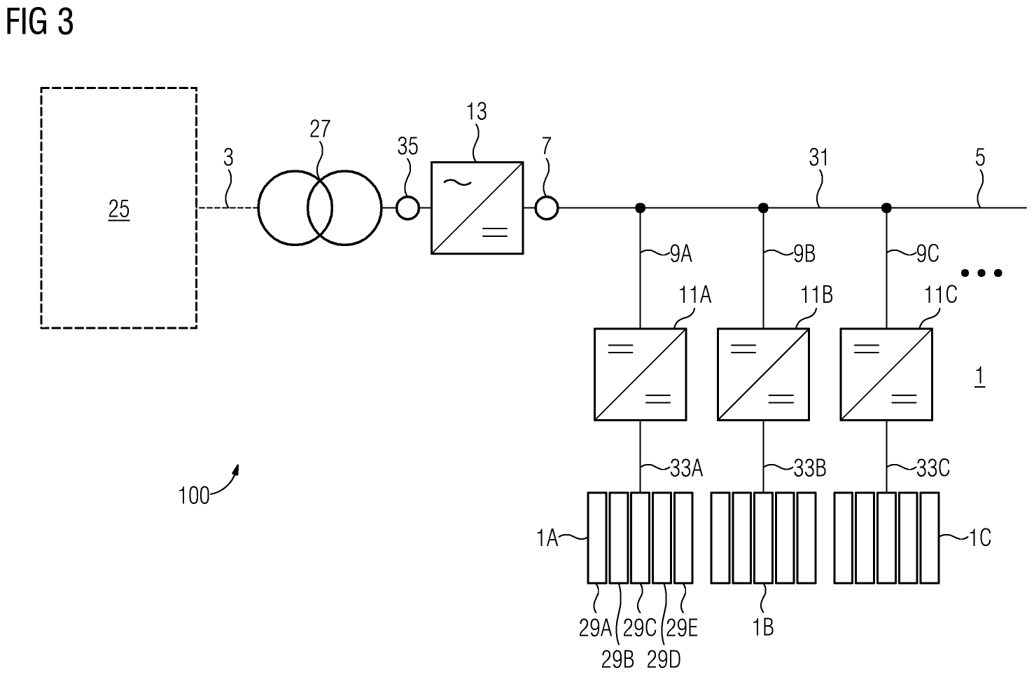

FIG. 3 shows a DC bus supply topology having the central supply line for direct current, and electrolysis installations which are connected thereto;

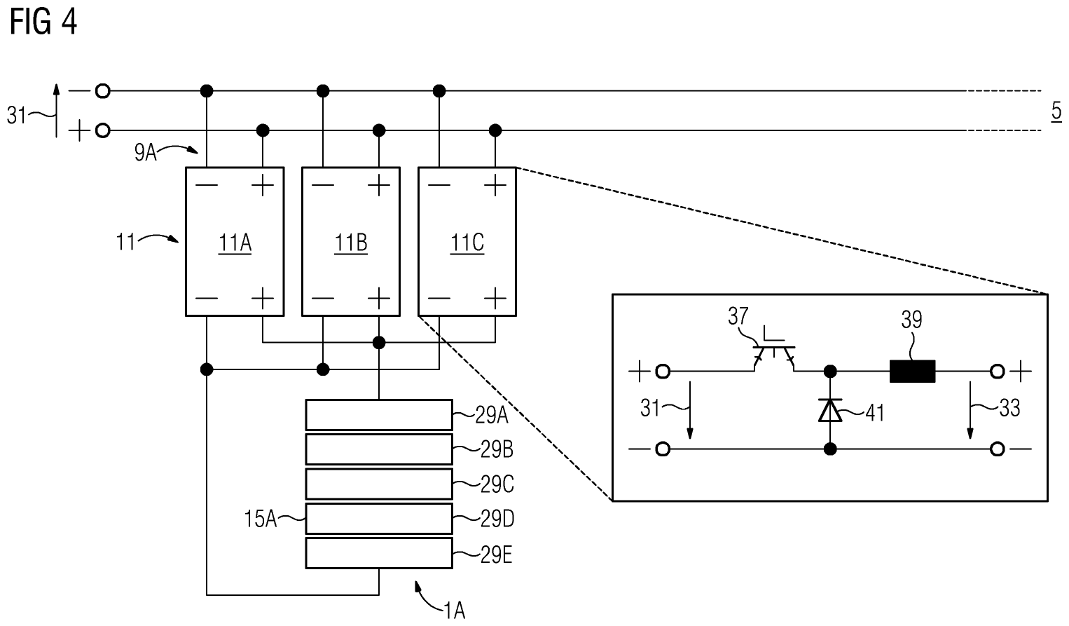

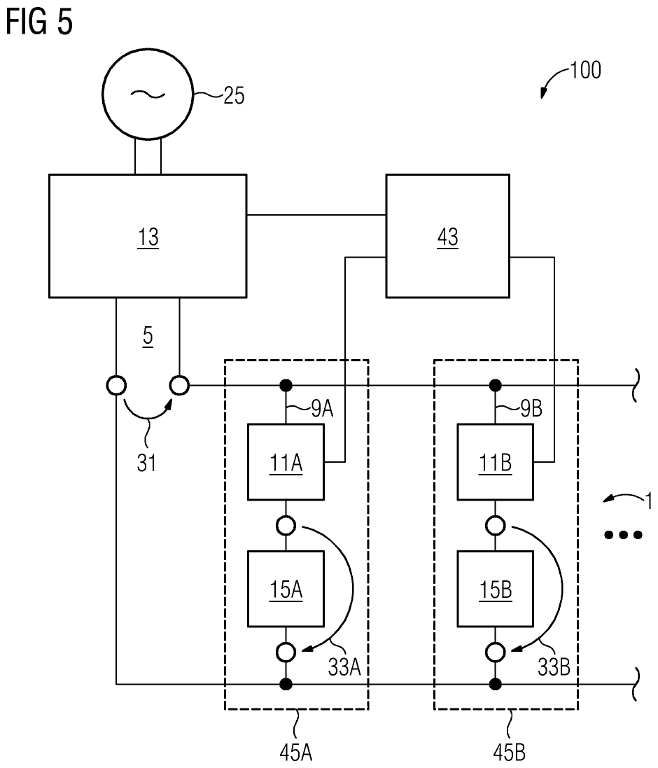

FIG. 4 shows a section of the supply topology according to FIG. 1, having a step-down converter of modular design, comprised of multiple DC/DC converters;

FIG. 5 shows a schematic block circuit diagram of the supply topology of an electrolysis system having a central modular multilevel converter (MMC) at the network connection point;

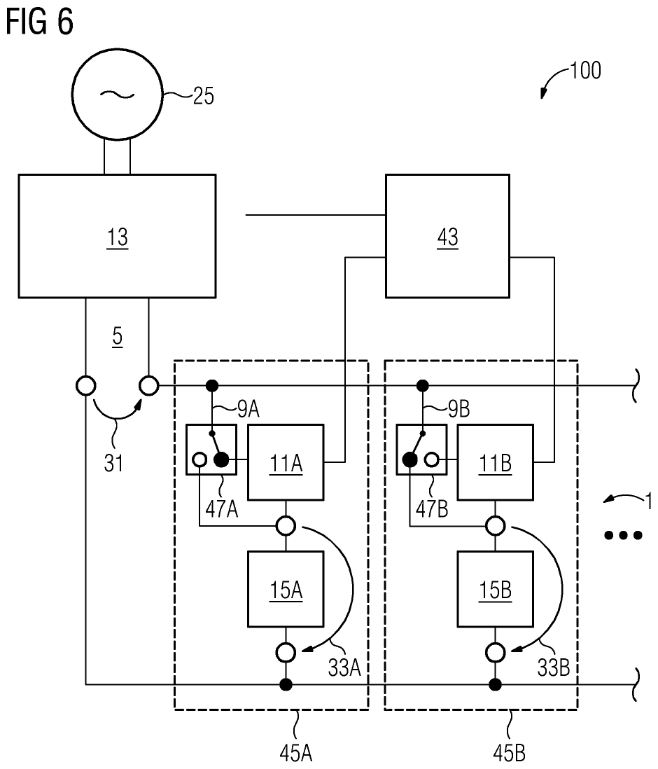

FIG. 6 shows a supply topology of an electrolysis system according to FIG. 5, having a bridging arrangement.

In the figures, identical reference symbols assume an identical meaning.

An electrolysis system 100 according to the invention is represented in FIG. 1. The electrolysis system 100 comprises an electrolysis unit 1 having two electrolysis installations 1A, 1B, and a power supply source 3 which is connected to the electrolysis unit 1. The power supply source 3, by way of a power generator, comprises a wind power installation 19, which is employed as a renewable energy installation (RE installation) and as a source of green electricity. The supply of the electrolysis system 100 with electrolysis current is executed via a central supply line 5, which is energized with a DC voltage, such that the central supply line 5 forms a central DC bus conductor, by means of which a direct current for the electrolysis process can be fed directly to the electrolysis unit 1.

Each of the electrolysis installations 1A, 1B of the electrolysis system 100, by means of a respective connection line 9A, 9B, is connected to the central supply line 5 at a supply terminal 23A, 23B, such that a parallel connection of the electrolysis installations 1A, 1B is executed. The electrolysis installation 1A comprises at least one electrolyser 15A, and the electrolysis installation 1B comprises at least one electrolyser 15B. The electrolysers 15A, 15B can optionally be configured as PEM electrolysers, as AEM (anion exchange membrane) electrolysers, or as alkaline electrolysers, wherein combinations hereof are also possible. It is possible for a multiplicity of electrolysers 15A, 15B to be consecutively arranged in-circuit in a train of the respective electrolysis installation 1A, 1B which is to be supplied, by means of the corresponding connection line 9A, 9B.

On the side of the power supply source 3, a rectifier 13A is connected down-circuit of the wind power installation 19, on the output side of a generator of the wind power installation 19, which comprises a DC voltage output 7. Thus, an alternating current which is generated by the generator of the wind power installation 19 can be converted into a direct current at a predetermined first DC voltage 31, and injected into the central supply line 5 at the DC voltage output 7. A central DC grid which is rated to a predetermined first DC voltage 31, for example to a medium DC voltage, is embodied accordingly. For the infeed of electric power which is generated by the wind power installation 19 and injected into the central supply line 5, no further active components, such as transformers, are required at the connection of the wind power installation 19 to the central supply line 5, such that a particularly simple supply topology is achieved.

The DC voltage level at the DC voltage output 7 of the rectifier 13A is flexibly adaptable to the respective requirement of the electrolysis system 100, wherein a high output voltage at medium-voltage level is preferably selected as the predetermined first DC voltage 31, and is at least greater than 1.5 kV. Typically, a medium-voltage level of 20 kV is set for the first DC voltage 31. For the first DC voltage 31 on the central supply line 5, in the design rating and configuration of the central DC grid formed by the central supply line 5, recourse is also possible, for example, to the rated voltages of system levels which are customarily employed for energy transmission, or these values can be employed as reference points for the DC voltage level. Electrical energy is transmitted on high-voltage lines, at various medium-voltage and high-voltage system levels, at the following customary rated voltages: a medium voltage of 3 kV, 6 kV, 10 kV, 15 kV, 20 kV or 30 kV, or a high voltage of 60 kV or 110 kV. The central supply line 5 thus functions, in a highly advantageous manner, as a central DC bus conductor, by means of which a high-voltage-based DC power supply of connected electrolysis installations 1A, 1B which are in an electrolysis system 100 is directly enabled.

For a connection and DC power supply of electrolysis installations 1A, 1B which are attuned to the respective second DC voltage 33A, 33B, by way of an operating voltage, a step-down converter 11A is connected in the connection line 9A and, correspondingly, a step-down converter 11B is connected in the connection line 9B. The step-down converters 11A, 11B, also described as buck regulators, are based upon IGBT technology, i.e. upon transistor technology, conversely to the thyristor technology which has customarily been employed to date, such that an individual load control of individual electrolysis trains in the connection lines 9A, 9B is provided. The input of the step-down converter 11A is thus connected to the supply terminal 23A and, in an analogous manner, the input of the step-down converter 11B is connected via the supply terminal 23B to the central supply line 5. On the output side, the step-down converters 11A, 11B are respectively connected to the electrolyser 15A, 15B in the connection line 9A, 9B such that, for electrolysis in the electrolysers 15A, 15B, a respective direct current is delivered at a respectively adjustable voltage level of a second DC voltage 33A, 33B, by way of an operating voltage. In the operation of the electrolysis system 100, on the central supply line 5, a medium-voltage DC power grid is provided by way of a central DC grid at the first DC voltage 31, and is employed for supplying electrolysis current to electrolysis installations 1A, 1B which are connected to the central supply line 5, in a parallel-connected arrangement. By the employment of a high voltage, a direct current can be delivered, and DC electric power can be injected into the central supply line 5. The electrolysis system 100 can thus be designed or extended in a particularly flexible manner wherein, for example, further electrolysis installations 1A, 1B comprising further electrolysers 15A, 15B are connected by means of a connection line 9A, 9B. Optionally, by means of the electrolysis system 100, an off-grid separate network operation is enabled, provided that no take-up of power from the public power grid 25 is executed.

Preferably, however, a take-up of electric power and a connection to the public power grid 25 are provided at a central network connection point 25.

The step-down converters 11A, 11B which are connected in the connection line 9A, 9B are embodied in the form of DC/DC converters (buck regulators), and are respectively rated such that the input voltage thereof corresponds to the predetermined first DC voltage 31 in the central DC grid on the central supply line 5, and the respective output voltage thereof is adjusted or set to a respective second DC voltage 33A, 33B, by way of a respective operating voltage of the connected electrolysis installation 1A, 1B. The step-down converters 11A, 11B are configured as controllable buck regulators, such that the supply of electrolysis current to the electrolysis installation 1A, 1B can be adjusted and matched to a fluctuating input power of the power supply source 3 into the central supply line 5. The step-down converters 11A, 11B can be configured, for example, as controllable buck regulators for controlling the output voltage by means of a pulse-width modulation method in continuous operation, thus enabling continuous operation with a specific performance capability. The step-down converters 11A, 11B are embodied with an IGBT-based design, such that an individual load control in the electrolysis installation 1A, 1B is achieved. By means of the IGBT-based embodiment of the step-down converters 11A, 11B, the influence of grid system perturbations from the public power grid 25 is restricted, and a substantial isolation is achieved, such that a stable operation is enabled.

In the electrolysis system 100 represented in FIG. 1, it is also possible that an electrolysis installation 1A, 1B is arranged, for example, at the base of the tower of a respective wind power installation 19 and, at this location, is directly connected to the central supply line 5. This is advantageous, for example for on-shore applications and settings of wind power installations 19 in remote locations, and for separate network operation. In this context, a wind power installation 19 is also to be understood as a wind farm or wind park—whether on-shore or off-shore—comprising a multiplicity of wind power installations 19.

According to the exemplary embodiment represented in FIG. 1, on the side of the power supply source 3, a connection to the public power grid 25 is additionally configured in the electrolysis system 100. To this end, as illustrated in FIG. 1 by a broken line, a separate supply terminal 23C is provided in the central supply line 5. The connection to the public power grid 25 is executed via a connection transformer at the network connection point 35 and a down-circuit central modular multilevel converter 13, which comprises a DC voltage output 7. The central modular multi-level converter 13 is based upon IGBT technology, and comprises a corresponding number of IGBTs, by way of power components. The modular multilevel converter (13) is one potential and preferred specific configuration of a voltage source converter (VSC). Consequently, in principle, other VSC-based converters can also be employed at the network connection point 35 for the injection of power from the public power grid 25 into the central supply line 5.

The modular multilevel converter 13 is configured and adjustable in a flexible manner such that, at the DC voltage output 7 thereof, the first DC voltage 31 is supplied and is injected into the central supply line 5. Corresponding voltage levels for the first DC voltage are optionally obtained, for example, from medium-voltage levels of 3 kV, 6 kV, 10 kV, 15 kV, 20 kV or 30 kV, or from high-voltage levels of 60 kV or 110 kV. The voltage level is flexibly adaptable and variable accordingly. Moreover, by means of the modular multilevel converter 13, a bidirectional operation is enabled by the employment of the supply terminal 23C as a network connection such that, if required, an injection of direct current from the public power grid 25 into the central supply line 5 and an outfeed of direct current from the DC grid of the central supply line 5 at the first DC voltage 31 are enabled.

Thus, if required, power from the public power grid 25 can also be injected into the central supply line 5 at the supply terminal 23C, at an appropriate voltage level, and can be supplied for use in the electrolysis system 1, for the purposes of electrolysis. It is advantageous that, by the provision of a connection to the public power grid 25, for example, replacement capacity demand can be fulfilled, for example in the event that the wind power installation 19, on the grounds of maintenance, is not generating power, or is only generating power to a very limited extent, or during phases of cloudy and windless conditions, such that a back-up solution is maintained, in the interests of ensuring the most continuous supply possible and a consistent operation of the electrolysis installations 1A, 1B for hydrogen production. Optionally, in the event of a shortfall in the DC electric power supply on the central supply line 5, it is also possible for one or more electrolysis installations 15A, 15B to function in part-load operation, or to be removed from the DC grid. An appropriate part-load operation, if required, in the respective connection line 9A, 9B is achieved by means of the controllable step-down converters 11A, 11B, by means of which the DC power is respectively adjustable at the output of the step-down converter 11A, 11B, according to the respective second DC voltage 33A, 33B. In an exclusive separate network operation of the interconnected installations, in the absence of an available option for connection to a public grid 29, it is not generally possible for any replacement capacity demand to be supplied. In this case, however, by a dedicated set-up and provision of “redundancy”, or by the provision of a system reserve in the separate network, with respect to the infeed from the wind power installation 19 or a photovoltaic installation 21 (see FIG. 2), e.g. by means of a modular design of these RE injection systems and the installation of a number of reserve modules in the electrolysis installations 15A, 15B, a substantially maintenance-independent supply and uninterrupted operation can be achieved in a substantially autonomous manner. It is also possible for common reserve modules to be consolidated and provided for multiple central supply lines 5, which are either switch-selectable or which, by means of a coupling facility of the central supply lines 5, contribute to the supply of multiple supply lines.

By the employment of a modular multilevel converter 13 in the form of an IGBT-based rectifier, only a very limited emission of harmonics occurs at the network connection point 35. Any additional filtering can be omitted altogether or, in any event, is only necessary to a significantly lesser degree than in comparable thyristor-based systems. The reactive power demand of this connection and supply topology can be adjusted in a flexible manner. In consequence, only a very limited reactive power compensation, or none whatsoever, is required.

By means of the individually adjustable reactive power demand of the IGBT-based modular multilevel converter 13 by way of a central rectifier system, this system, in addition to the supply of controlling power, can also contribute to voltage support on the public power grid 25. In separate networks, e.g. in local renewable energy networks, these IGBT-based modular multilevel converters 13 can moreover execute a network configuration function.

In this design concept, RE installations, which themselves deliver a DC voltage, can inject power directly into the DC bus. The inverter which is required in the event of the employment of thyristor-based rectifiers can be omitted. As a result, additional conversion losses are eliminated. In the event that more power is injected into the DC bus, which functions as a central supply line 5, than is consumed by electrolysis operations in the electrolysis unit 1, the IGBT-based converter 13 at the network connection point 35 is also capable of injecting surplus power into the public power grid 25. By means of this type of association or electrical interconnection of individual electrolysis installations 1A, 1B via the central supply line 5, an isolation of systems can be executed. Electrolysis trains of the electrolysis installations 1A, 1B, or the respective electrolysers 15A, 15B, can be operated at individual respective working points. Scope for the control of the overall electrolysis system 100 is also increased as a result.

In a further exemplary embodiment of an electrolysis system 100 according to the invention, an alternative power supply source 3 for supplying direct current to the electrolysis unit 1 is represented in FIG. 2. The power supply source 3 comprises a photovoltaic installation 21, having a multiplicity of PV modules, which are not represented in greater detail. The photovoltaic installation 21 can be configured, for example, as an extensive and high-performance open-air installation—preferably in regions of high sunshine—such that PV capacities of 10 MWe or higher are available for electrolysis. On the side of the electrolysis unit 1, an essentially analogous installation concept to that represented in FIG. 1 is employed, with corresponding installation components, i.e. the electrical connection and supply of electrolysis installations 1A, 1B is executed via the central supply line 5 which, in turn, is embodied as a central DC bus conductor or DC connection link. In order to achieve this, the electrolysis installation 1A is electrically connected to the supply terminal 23A and, correspondingly, the electrolysis installation 1B is electrically connected to the supply terminal 23B, by means of a respective connection line 9A, 9B, in which the respective IGBT-based step-down converters 11A, 11B are connected.

In the electrolysis system 100 thus configured, the power supply source 3 thus comprises a photovoltaic installation 21 by way of a power generator, or a “PV generator”. By definition, this generator delivers a DC voltage at the generator output, which is already rated to the predetermined first DC voltage 31, wherein the DC voltage output 7 is formed by the PV generator output, and is directly connected to the central supply line 5.

However, with respect to the photovoltaic installation 21 by way of a power supply source 3, in order to achieve a desired and advantageous DC voltage level of the first DC voltage 31 for the injection of DC power into the central supply line 5, it is also possible, as represented in the exemplary embodiment according to FIG. 2, that a step-up converter 17 is connected at the DC output of the PV generator of the photovoltaic installation 21.

In power electronics, the step-up converter 17, also described as a boost converter or boost regulator, is a particular form of a DC voltage converter. The magnitude of the output voltage is consistently greater than the magnitude of the input voltage such that, by means of the step-up converter 17, the desired DC voltage level at the DC voltage output 7 is delivered for an injection of the pre-determined first DC voltage 31. A higher voltage reduces material requirements, and thus reduces the cost of lines down-circuit of the injection from the power supply source 3.

The step-up converter 17 is rated for the voltage level and, at the output thereof, delivers the first DC voltage 31. The step-up converter 17 is configured with a controllable design, such that a flexible adjustment of the output voltage supplied is enabled. The coupling and injection of power from the photovoltaic installation 21 into the central supply line 5 are executed directly at the DC voltage output 7 of the step-up converter 17. For transmission and the take-up of electric power by the electrolysis unit 1, the electrolysis installations 1A, 1B—as described in greater detail above—are connected to the central supply line 5 by means of a respective connection line 9A, 9B. By means of the respective step-up converter 11A, 11B, moreover, an isolation of the regulation of electrolysis power demands in the connection lines 9A, 9B is achieved, and an individual operating mode of these DC connection trains is thus enabled, which is particularly significant in the case of part-load demands. In the case of a PV application, an injection of mains power from the public power grid 23 into the central supply line 5 is also possible, and is executed in an analogous configuration to that described with reference to FIG. 1, by means of a central modular multilevel converter 13 at the network connection point.

The fundamental concept for the supply and coupling of multiple electrolysis installations 1, 1A, 1B by means of a central DC bus supply line 5 is represented in a schematic and simplified manner in FIG. 3. A three-phase AC power terminal is embodied at the network connection point 35. At the network connection point 25, a central IGBT-based modular multilevel converter 13 is connected at the AC input, at the DC output 7 of which the central supply line 5 is connected as an outgoing DC bus. By way of an output voltage, the modular multilevel converter 13 delivers the first DC voltage 31, for example a medium voltage at 20 kV. The electrolysis unit 1 comprises multiple electrolysis installations 1A, 1B, 1C which, in turn, comprise a plurality of electrolysis modules 29A, 29B, 29C, 29D, 29E which are electrically arranged consecutively in-circuit. Each electrolysis installation 1A, 1B, 1C is connected by means of a respective connection line 9A, 9B, 9C to the central supply line 5. For the supply of a respective second DC voltage 33A, 33B, 33C, in each case, a step-down converter 11A, 11B, 11C, which is based upon IGBT technology, is connected in the connection lines 9A, 9B, 9C. In each case, the level of the second DC voltage 33A, 33B, 33C can thus be controlled or regulated. A bidirectional operation is achieved by means of the IGBT-based modular multilevel converter 13, such that surplus power on the central supply line 5 can be injected via the network connection point 35 into the public power grid 25.

A facility for the injection of direct current from a renewable energy installation (RE installation) into the central supply line 5 is not represented in greater detail in FIG. 3. With respect hereto, reference is made to the exemplary embodiments according to FIG. 1 and FIG. 2.

By the concept for the supply and coupling of multiple electrolysis installations 1A, 1B, 1C, in a respective connection line 9A, 9B, 9C, a regulated DC voltage supply to the electrolysis installations 1A, 1B, 1C thus supplied, having the electrolysis modules 29A-29E is achieved, wherein two DC voltage levels are considered accordingly. It is thus possible for the total electrolysis power in a connection line 9A, 9B, 9C, by means of the regulated DC power, to be adjusted in a demand-specific manner in each case by the respective regulation of the second DC voltage 33A, 33B, 33C. In particular, a part-load operation can be introduced in an electrolysis installation 1A, 1B, 1C, in the event that the supply of electric power on the central DC supply line 5 is reduced, or in the event that a short-term reduction of hydrogen production is required. It is also possible, and particularly advantageous, that the electrolysis modules 29A-29E of an electrolysis installation 1A, 1B, 1C, can be bridged, individually and module-by-module, by means of a bridging circuit—which is not represented in greater detail in FIG. 3—having a switchable bridging line and having an actuatable electric switch, and that, if required, or optionally, one or more electrolysis modules 29A-29E of an electrolysis installation 1A, 1B, 1C can thus be withdrawn from service, for example for maintenance purposes or for the introduction of a requisite part-load operation of the respective electrolysis installation 1A, 1B, 1C, or of selected electrolysis modules 29A-29E thereof, e.g. according to a degree of ageing or a forthcoming maintenance interval.

The concept of the modular execution of a DC/DC conversion in a step-down converter 11 is described, in an exemplary manner, with reference to FIG. 4. In one section, the supply topology according to FIG. 3 is represented, having a step-down converter 11 of a modular design, which is comprised of multiple parallel-connected DC/DC converters 11A, 11B, 11C, and which supplies an electrolysis installation 1A. Two DC voltage lines having a corresponding positive and negative polarity are provided for the central supply line 5, to which the DC/DC converters 11A, 11B, 11C, at the DC voltage input thereof, are respectively connected, with the correct polarity, as modules of the step-down converter 11. By means of this parallel connection, a connection line 9A is formed for supplying the electrolysis installation 1A. The electrolysis installation 1A incorporates an electrolyser 15A, which comprises multiple electrolysis modules 29A-29E.

The employment of IGBT-based DC/DC converters 11A, 11B, 11C enables an individual load control of the electrolysis installation 1A which is connected by means of a connection line 9A, with no significant influence upon grid system perturbations. By means of the modular design of the step-down converter 11, comprising multiple DC/DC converters 11A, 11B, 11C, a greater installation flexibility may be achieved, with a viable reduction of costs, and redundancy is provided in the interests of reliable operation. The modular design of the step-down converter 11 thus enables at least a reduced further operation of the electrolysis installation 1A in the event of individual semiconductor faults on components, thus providing an advantage over known design concepts, in which semiconductor faults result in a loss of the rectifier train or of the associated electrolyser 15A, which it would be necessary to rectify by repairing the installation in a shutdown condition.

The DC/DC converters 11A, 11B, 11C respectively comprise a transistor 37, which is embodied in the form of an IGBT, a choke coil 39 and a diode 41, as illustrated in the exploded representation according to FIG. 4. The transistors 37 and the choke coils 39 are respectively arranged in series with the electrolyser 15A which is to be respectively supplied by means of a step-down converter 11. Correspondingly, the diodes 41 are respectively connected in parallel with the respective electrolyser 15A. By means of the transistor 37, the respective second DC voltage 33 which is delivered by the step-down converter 11, and which drops across the electrolyser 11A, can be regulated with respect to the magnitude thereof. To this end, the transistors 37 can be connected, for example, to a computing device 43 which is not represented in greater detail in FIG. 4—c.f. FIG. 5 and the associated description—wherein the corresponding actuation for regulating and/or controlling the step-down converter 11 is executed by means of the computing device 43. It is possible that the electrolysis modules 29A-29E of the electrolysis installation 1A or of the electrolyser 15A are individually bridged by means of a bridging circuit, which is not represented in greater detail in FIG. 4. The bridging circuit can be equipped with a switchable bridging line and with an actuatable electric switch, such that a bridging can be executed, individually and module-by-module. As a result, if required, or optionally, one or more electrolysis modules 29A-29E of the electrolysis installation 1A can be withdrawn from service. This is highly advantageous, for example for maintenance purposes or for the introduction of a requisite part-load operation of the respective electrolysis installation 1A, or of selected electrolysis modules 29A-29E thereof, e.g. according to a degree of ageing or a forthcoming maintenance interval.

In combination with the IGBT-based modular multilevel converter at the network connection point 35, according to the exemplary embodiments represented in FIG. 1 to FIG. 3, a supply of further network services for the public power grid 25 is enabled. Renewable energy installations (RE installations), additionally and if required, can inject power directly into the central supply line 5, in the form of the DC bus—which is not explicitly represented in FIG. 3 and FIG. 4—and the electrolysis installations 1A, 1B, 1C can be regulated in a mutually independent manner. Rectification of alternating current from the public power grid 25 is executed only once, in a central manner at the network connection point 35. To this end, for the connection of the installation to a medium-voltage network, an IGBT-based modular multilevel converter 13 is employed as a central component for supplying the first DC voltage to the central supply line 5.

A schematic and highly simplified representation of a section of an electrolysis system 100 is represented in FIG. 5. This is intended to illustrate only a particularly advantageous circuit connection and bridging concept in the electrolysis system 100. A circuit is provided for the supply of direct current to a plurality of electrolysers 15A, 15B which are mutually electrically connected in parallel, wherein the electrolysers 15A, 15B are respectively parallel-connected, by means of an IGBT-based step-down converter 11A, 11B, to the output of a central modular multi-level converter 13, which functions as a rectifier. The modular multilevel converter 13 converts an input-side AC voltage which is present on the public power grid 25 into a first DC voltage 31 and is IGBT-based. This first DC voltage 31 drops across the parallel connection spurs 45A, 45B formed by the connection lines 9A, 9B, which spurs respectively incorporate one of the electrolysers 15A, 15B and one of the step-down converters 11A, 11B. The first DC voltage 31 is converted by the step-down converter 11A into the second DC voltage 33A, which drops across the electrolyser 15A. Correspondingly, the first DC voltage 31 is also converted by the second step-down converter 11B into the second DC voltage 33B, which drops across the electrolyser 11B. In addition to the two electrolysers 11A, 11B represented in the electrolysis system 100, naturally, the supply topology represented can also be employed for the supply of DC voltage to further electrolysers which, correspondingly, are also respectively connected via a step-down converter to the output of the central modular multilevel converter 13, in a further parallel-connected spur, for example according to FIG. 3.

In order to enable the operation of the electrolysers 15A, 15B at a desired working point which, for example, lies within a secure operating range, the step-down converters 11A, 11B can be controlled and/or regulated for adjusting a level of the second DC voltage 33A or 33B. Additionally, the modular multilevel converter 13 can also be controlled and/or regulated for adjusting a level of the first DC voltage 31. DC power can thus be injected into the central supply line 5 at a predetermined first DC voltage 31. In particular, it can be provided that both the modular multi-level converter 13 and the step-down converters 11A, 11B and, optionally, any further step-down converters which are present in further connection spurs, can be controlled or regulated. For the control or regulation of the rectifier and/or of the step-down converters 11A, 11B, the supply topology of the electrolysis system 100 can comprise, for example, a computing device 43, by means of which the modular multilevel converter 13 and/or the step-down converters 11A, 11B can be actuated or regulated. To this end, the computing device 43 can be connected to one or more measuring devices—which, in the present case, are not represented in greater detail—by means of which, for example, a quantity of material which is generated by one of the electrolysers 15A, 15B, a respective resistance of one or more of the electrolysers 15A, 15B, and/or a respective current flux in one or more of the electrolysers 15A, 15B can be ascertained. The control and/or regulation of the modular multilevel converter 13 for adjusting the level of the first DC voltage 31, or a control or regulation of the step-down converters 11A, 11B for adjusting the level of the second DC voltage 33A, 33B, can thus be executed, for example, according to the quantity of material thus determined and/or according to the respective resistance or, optionally, according to further influencing variables of the electrolysers 11A, 11B and/or of the respective current flux in the electrolysers 11A, 11B. External factors include, for example, the present electricity price and the availability of power generation from renewable energy. The same applies correspondingly to further electrolysers, and to further step-down converters which may be present, additionally to the connection spurs 45A, 45B. The step-down converters 11A, 11B and, optionally, any further step-down converters which may be present, are constituent elements of the supply topology of the electrolysis system 100, to which the electrolysers 11A, 11B and, optionally, any further electrolysers which are present, can be connected.

FIG. 6 shows a supply topology of an electrolysis system 100 according to FIG. 5, having a bridging device. According to the exemplary embodiment represented in FIG. 6, it is additionally provided that actuatable bridging switches 47A, 47B having a respective activatable switching element are incorporated, which are also actuatable by means of the computing device 43 such that, in the event of a correspondingly closed switch, the step-down converters 11A, 11B can be bridged. In the event that a step-down converter 11A, 11B is bridged by means of the bridging switches 47A, 47B, i.e. in the event that a corresponding switching element is activated for bridging a respective bridging path, the first DC voltage 31 generated by the modular multilevel converter 13 drops directly across the electrolyser 11A or 11B, thus bridging the respective step-down converter 11A, 11B. In the event of bridging, the corresponding electrolysers 15A, 11A, if required and optionally, are thus supplied directly with the first DC voltage 31 from an intermediate circuit, via the respective connection line 9A, 9B. Thus, in FIG. 6, exemplarily, the bridging switch 47A is activated, i.e. the corresponding switch for the bridging path is closed, and the step-down converter 11A is bridged. The bridging switch 47B is not activated. In this case, the switching element of the bridging switch 47B is switched to a circuit state for energizing the step-down converter 11B. In the electrolysis system 100, a bridging device is thus provided, having a plurality of actuatable bridging switches 47A, 47B, and enables a particularly advantageous and energy-efficient capacity utilization control of electrolysis installations 1A, 1B which are connected to the central DC supply line.

In the electrolysis system 100, an electrolysis unit 1, additionally to the supply topology described, also comprises all the electrolysers which are connected thereto. These can respectively comprise, for example, at least one proton exchange membrane which, in particular, is configured for the generation of hydrogen by the electrolysis of deionized and/or distilled water. However, it is also possible for electrolysers based upon alkaline electrolysis or upon an anion exchange membrane electrolysis to be employed.

In the electrolysis system 100, the employment of a modular multilevel converter 13 (MMC converter) enables a central supply of DC power and a DC power transmission, in a bidirectional manner. By means of the modular multilevel converter 13, over and above the actual transmission function, network services can also be provided. An application in combination with electrolysis installations in an electrolysis system 100 having a central supply line 5 which is configured as a DC bus, according to the present invention, is particularly advantageous. The employment of parallel-connected modular high-current DC/DC converters for the second DC voltage 22 in the electrolysis system 100, in combination with an electrolysis installation 11A, 11B, is highly advantageous for an industrial application. The coupling of electrolysis installations 11A, 11B by means of a DC bus in a large-scale hydrogen production plant is enabled accordingly.

Although the invention has been described in detail, and illustrated in greater detail with reference to the preferred exemplary embodiment, the invention is not limited by the examples disclosed, and further variations can be inferred herefrom by a person skilled in the art, without departing from the protective scope of the invention.

1-12. (canceled)

13. An electrolysis system, comprising:
a power supply source having a DC voltage output and a central supply line connected to said DC voltage output of said power supply source, wherein said DC voltage output is configured to inject a direct current at a first DC voltage into said central supply line;
a voltage source converter connected at a network connection point for supplying DC power from a public power grid, said voltage source converter being configured to convert an input-side AC voltage into the first DC voltage at a DC voltage output thereof;
at least two electrolysis installations electrically connected in parallel to said central supply line;
each of said electrolysis installations being connected in parallel via a respective DC/DC converter, which is configured to convert the first DC voltage into a second DC voltage, to said DC voltage output of said voltage source converter, such that the second DC voltage drops across the respective said electrolysis installation, and wherein each of said DC/DC converters is controllable for adjusting a level of the second DC voltage thereof; and
actuatable bridging switches connected to enable a respective said DC/DC converter to be bridged, when a bridging switch is closed, and the respectively connected said electrolysis installation to be directly energized by the first DC voltage.

14. The electrolysis system according to claim 13, wherein said DC/DC converter is an IGBT-based step-down converter for an individual load control of said electrolysis installation.

15. The electrolysis system according to claim 13, wherein said voltage source converter is configured for bidirectional operation and is connected to a central network connection point, enabling a voltage support function to be executed by supplying reactive power for the public power grid.

16. The electrolysis system according to claim 15, wherein said voltage source converter is an IGBT-based modular multilevel converter configured, if required, to enable electric power to be injected from said central supply line into the public power grid at said network connection point.

17. The electrolysis system according to claim 13, wherein said electrolysis installations, with respect to said central supply line, are connected in a mutually parallel arrangement, with an electrolysis installation being connected by way of a respective connection line to said central supply line.

18. The electrolysis system according to claim 17, which further comprises a respective IGBT-based step-down converter connected in said connection line, wherein an input voltage of said step-down converter corresponds to the first DC voltage, and a second DC voltage of said step-down converter is adaptable to an operating voltage of the respective said electrolysis installation.

19. The electrolysis system according to claim 18, wherein said step-down converter in a given said connection line is embodied with a modular design, wherein said step-down converter comprises at least two parallel-connected DC/DC step-down converters having an input voltage corresponding to the first DC voltage.

20. The electrolysis system according to claim 19, wherein said at least two parallel-connected DC/DC step-down converters of said modular step-down converter are mutually electrically connected on an output side and are respectively configured for regulating the second DC voltage.

21. The electrolysis system according to claim 20, wherein said modular step-down converter is connected to an electrolysis installation having a plurality of electrolysis modules which are electrically arranged in series.

22. The electrolysis system according to claim 13, wherein said power supply source comprises a wind power installation, forming a power generator, and a rectifier connected to said wind power installation having a DC voltage output rated for the first DC voltage.

23. The electrolysis system according to claim 13, wherein the power supply source comprises a photovoltaic installation, forming a power generator, said photovoltaic installation having a DC voltage output rated for the first DC voltage connected to said central supply line.

24. The electrolysis system according to claim 13, wherein said central supply line is rated for operation at the first DC voltage of 20 kV.

25. The electrolysis system according to claim 13, wherein said central supply line is rated for operation at the first DC voltage in a medium-voltage range between 1.5 kV and 30 kV.
